(19) United States
(12) Patent Application Publication
(10) Pub. No.: US 2014/0259049 A1
(43) Pub. Date: Sep. 11, 2014

(54) Viewer-Initiated Delivery of Supplemental Advertising Content

(71) Applicant: GENERAL INSTRUMENT CORPORATION, Horsham, PA (US)

(72) Inventor: Peng Wang, Harleysville, PA (US)

(73) Assignee: General Instrument Corporation, Horsham, PA (US)

(21) Appl. No.: 13/791,066

(22) Filed: Mar. 8, 2013

(51) Int. Cl. H04N 21/81

(52) U.S. Cl. CPC H04N 21/812
USPC 725/32

(57) ABSTRACT

Methods and apparatuses for providing selective access to supplemental program content may include receiving a program stream, outputting the program stream to a display, receiving an indication of a viewer request for supplemental program content, obtaining an identifier related to supplemental program content, requesting supplemental program content using the identifier, receiving reception information related to the supplemental program content, and receiving the supplemental program content based upon the reception information. Another method includes, but is not limited to, transmitting a first program stream, receiving a request for supplemental program content, the request comprising metadata, identifying supplemental program content using the metadata from the request, sending reception information for the identified supplemental program content, and transmitting supplemental program content in accordance with said reception information.

### FIELD

This disclosure relates to presentation of supplemental advertising content in response to viewer input.

### BACKGROUND

A fundamental problem with television advertising is the lack of relevance of many advertisements to many viewers. The ability to increase advertising relevance is hindered by a lack of knowledge regarding who is viewing a program, a lack of knowledge regarding the needs and desires of those viewers, and technological limitations on the ability to target advertisements.

Over time, cable systems have added the capability to target advertisement presentation to some extent. For instance, the targeted advertising approach detailed in the SCTE-130 standard allows operators to target advertisements to specific viewer groups based on geographic areas or predefined demographic profiles. Demographic information for a certain subsection of the cable system may be matched with advertisers' demographic targets to allow more appropriate selection of advertisements for presentation. However, individual viewers within a group still may not precisely fit the demographic profile or have needs related to many of the advertisements. Thus, even with targeted advertisement insertion, most advertisements may still not be relevant or of interest to most of the viewers.

Television viewership studies have shown that unwanted advertisements delivered in frequent program interruptions not only decrease the effectiveness of the advertisements, but also create viewer dissatisfaction towards the normal programming. Furthermore, even when a particular advertisement does happen to be relevant to a viewer, the fifteen-to-thirty-second time frame generally allocated to the advertisement may not be sufficient to convey adequate information. Thus, present advertisement presentation systems and methods fail to provide adequate targeting and viewer control over what is presented.

### BRIEF DESCRIPTION OF THE DRAWINGS

FIG. 1 is a simplified exemplary schematic representation of a bi-directional cable system.

FIG. 2 is a simplified exemplary schematic representation of software processes of a bidirectional cable system providing viewer-initiated presentation of supplemental advertising content.

FIG. 3 is a flow chart of a method for allowing viewer initiation of supplemental advertising presentation, shown from the perspective of a set-top box.

FIG. 4 is a flow chart of a method for allowing viewer initiation of supplemental advertising presentation, shown from the perspective of a headend.

### DETAILED DESCRIPTION

Disclosed herein are improved methods and associated apparatuses for viewer-initiated presentation of advertising. The disclosed techniques may allow a viewer to indicate that a particular advertisement is of interest and to view supplemental program content related to that advertisement. The supplemental program content may be delivered to the viewer's television screen, to a recording device for later viewing, or to a PC, mobile computing device, or other Internet capable device. The disclosed techniques may increase advertising effectiveness by providing the supplemental advertising only to those viewers who have expressed interest.

In embodiments, the method comprises, but is not limited to: receiving a program stream, outputting the program stream to a display, receiving an indication of a viewer request for supplemental program content, obtaining an identifier related to supplemental program content, requesting supplemental program content using the identifier, receiving reception information related to the supplemental program content, and receiving the supplemental program content based upon the reception information. By making delivery of supplemental program content contingent upon an expression of viewer interest, the method simultaneously avoids presenting the supplemental information to viewers who are not interested and presents more useful information to viewers who are interested.

In embodiments, the method comprises, but is not limited to transmitting a first program stream, receiving a request for supplemental program content, the request comprising metadata, identifying supplemental program content using the metadata from the request, sending reception information for the identified supplemental program content, and transmitting supplemental program content in accordance with said reception information.

In embodiments, the improved method is performed by an apparatus comprising, but not limited to: a first RF receiver for receiving a first program stream, a video output for outputting said first program stream to a display, a processor for performing the steps of: receiving an indication of a viewer request for supplemental program content, obtaining an identifier related to supplemental program content, requesting the supplemental program content using said identifier, and receiving reception information related to the supplemental program content, and a second RF receiver for receiving the supplemental program content based upon the reception information.

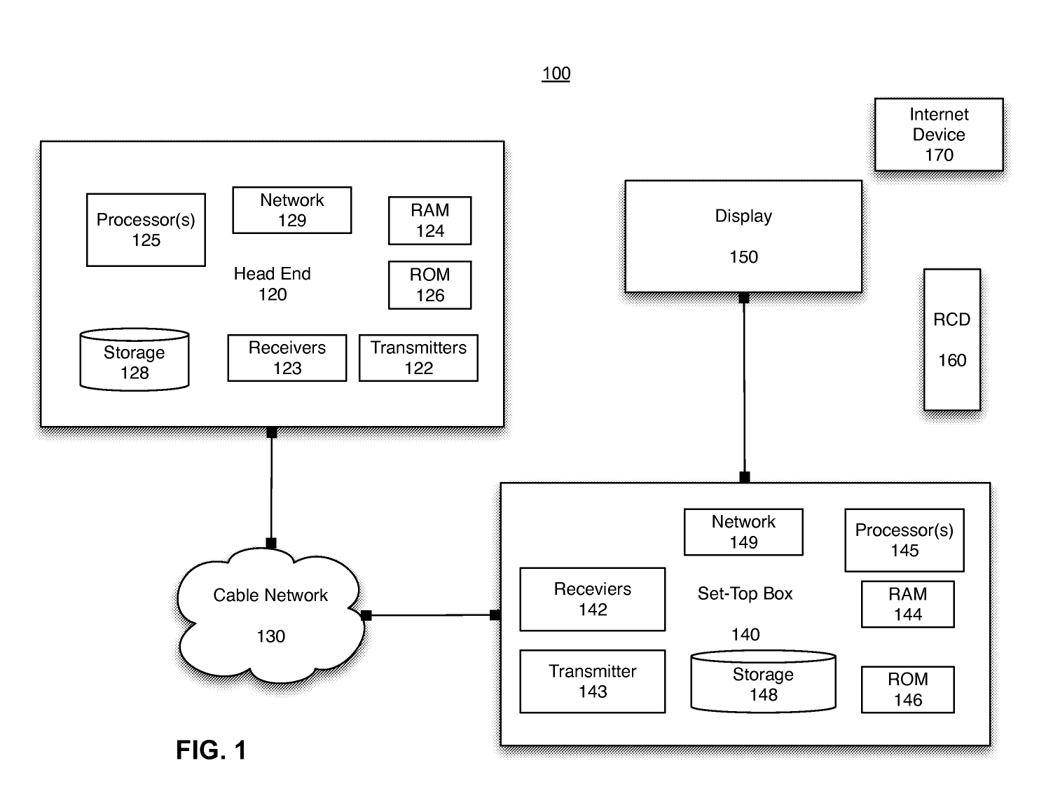

FIG. 1 is a simplified exemplary schematic representation of a bi-directional cable system. A cable headend 120 communicates with subscriber set-top boxes (STBs) 140 over the cable network 130.

Headend 120 may comprise a number of hardware components. Functions may be allocated amongst multiple systems, modules, or cards. Video service functions may be separate from, or combined with, cable modem service functions. In embodiments, headend 120 may comprise demodulators, receivers, advertisement servers, splicers, encoders, transcoders, multiplexers, splitters, combiners, conditional access components, and converter modules housed in one or more racks. The description below is simplified for the purpose of describing the viewer-initiated method for presentation of supplemental advertising. Those skilled in the art will recognize that various headend configurations may perform the described methods.

One or more transmitters 122 transmit program streams to STBs 140 over cable network 130. Transmitters may use a modulation such as Quadrature Amplitude Modulation (QAM). One or more of transmitters 122 may be part of one or more Edge QAM (EQAM) devices. An EQAM is a headend or hub device that receives packets of digital video or data from an operator network. The EQAM may re-packetize the video or data into MPEG transport streams and digitally modulate the transport stream onto a downstream RF carrier using QAM. The Edge QAM may also perform decryption and re-encryption of the video or data streams. In embodiments, traditional RF transmitters will be omitted and a general network interface may be used to transmit program streams over an IP network, for instance.

Receivers 123 receive upstream communications from STBs 140. The numbers of transmitters and receivers may vary, particularly based upon the number of channels supported by the system.

RAM 124 and/or ROM 126 may store instructions for microprocessor 125 to perform the processes describe herein. Processor 125 may execute program code for the coordination of operations of the components. In embodiments, multiple processors will be present in multiple components of headend 120.

Storage 128 may be used to store received or pre-loaded program or advertising content. In embodiments, storage 128 may comprise one or more hard disk drives or flash memory. Furthermore, any of the processes described below may be contained on a computer readable medium, which may be read by microprocessor 125. A computer readable medium may be any tangible storage medium capable of carrying instructions to be performed by a microprocessor, including a CD disc, DVD disc, magnetic or optical disc, tape, silicon based removable or non-removable memory.

Network interface 129 may facilitate IP-based communications amongst headend components or with STB 140. In embodiments, more than one network interface may be present for connection to different local and wide-area networks. In embodiments, viewer-initiated supplemental program content may be delivered via network interface 129 to STB 140 or to Internet Device 170.

Cable network 130 may comprise a coaxial network or hybrid fiber-coaxial (HFC) network. Various types of cabling may be used, such as coaxial wires, optical fibers, twisted pairs, and wireless connections. Upstream and downstream communications may be handled by the same or different processors, transceivers, and cabling. Cable network 130 may convey analog or digital video using RF or IP transmission methods, as well as cable modem traffic. Cable network 130 may carry a combination of broadcast, multicast, and unicast traffic.

STB 140 may also comprise a number of hardware components. One or more receivers 142 tune program streams received over cable network 130. In embodiments, receivers be omitted and a general network interface may be used to receive program streams over an IP network, for instance. In other embodiments, more than two tuners may be provided to allow enhanced simultaneous viewing and recording of more than two program streams. Transmitter 143 may transmit signals to headend 120 over cable network 130.

RAM 144 and/or ROM 146 may store instructions for microprocessor 145 to perform the processes illustrated in any or all of the following figures. Furthermore, any of the processes described below may be contained on a computer readable medium, which may be read by microprocessor 145. A computer readable medium may be any tangible storage medium capable of carrying instructions to be performed by a microprocessor, including a CD disc, DVD disc, magnetic or optical disc, tape, silicon based removable or non-removable memory.

Processor 145 may execute program code for the coordination of operations of the components. In embodiments, STB 140 may comprise more than one processor, or functions ascribed to the processor in this description may be divided amongst a processor and application specific integrated circuits (ASICs).

Storage 148 may be used to store received or pre-loaded program or advertising content. In embodiments, storage 148 may comprise one or more hard disk drives or flash memory.

Network interface 149 may facilitate IP-based communications between STB 140 and other devices on a network or with headend 120. In embodiments, more than one network interface may be present for connection to different local and wide-area networks. Network interfaces may utilize wired or wireless networking technologies. In embodiments, viewer-initiated supplemental program content may be delivered via network interface 149 to Internet Device 170.

STBs 140 are generally connected to displays 150 via analog or digital cabling, or via a computer network. Display 150 may be a television, monitor, or a computing device. STB 140 may output programming and STB user interface content to display 150. It is to be understood that in some embodiments, the described functions of STB 140 and display 150 may be co-resident in a single housing.

A Receiver Control Device 160 facilitates viewer interaction with STB 140. In embodiments, if a viewer is interested in a specific advertisement that is being displayed and desires more information about the products or services the advertisement is offering, the viewer may interact with the RCD 160 to request supplemental program content. RCD 160 may comprise a dedicated button for requesting supplemental program content, present an option for selection of supplemental program content on a display with associated buttons, or present such an option on a touch screen. RCD 160 also may facilitate selection of an option on the STB on-screen interface for requesting supplemental program content. RCD 160 may also be used to configure delivery of supplemental program content. A mobile computing device may serve in the role of RCD 160, and may communicate with STB 140 via a network.

An Internet Device 170 may also be present for viewing of primary or supplemental program content. Internet Device 170 may communicate with headend 120 via cable network 130, via a separate data network, or indirectly via communication with STB 140.

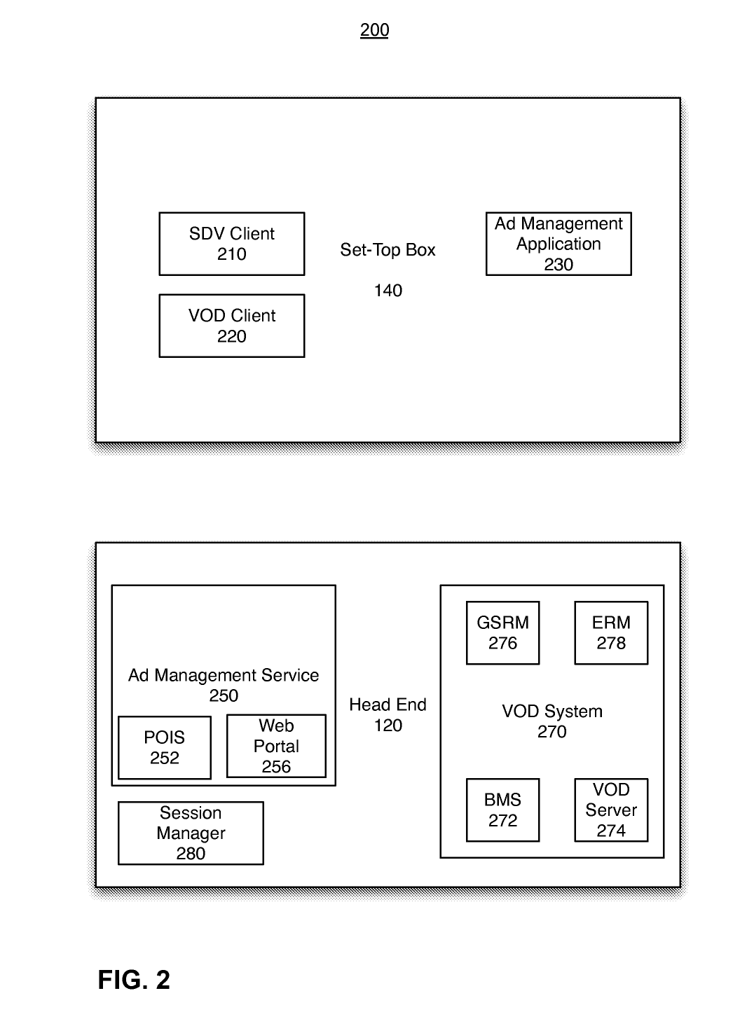

FIG. 2 is a simplified exemplary schematic representation of software processes of a bidirectional cable system providing viewer-initiated presentation of supplemental advertising content. It is to be understood that described functions of the exemplary software processes may be combined or further subdivided within the scope of the present disclosure. Furthermore, the processes may be executed on one or more processors in various combinations, and such processors may be located on one or more cards or in one or more housings in communication with each other. Additional processes may also be executed along with the described processes. In embodiments, processes of STB 140 may be executed by processor 145. Similarly, processes of headend 120 may be executed by processor 125.

At headend 120, Session Manager 280 may communicate with STBs 140 in order to, among other functions, establish and teardown Video On Demand and Switched Digital Video sessions. Session Manager 280 may establish a session with a STB 140 client which may request that video streams be directed to the STB and control the behavior of the stream. Session Manager 280 may be responsible for collaborating with other components at headend 120 to acquire the necessary resources to insure video streams can be delivered. In embodiments, VOD and SDV functions of Session Manager 280 may be separated into multiple process or platforms.

Ad Management Service (ADM) 250 comprises multiple processes for managing delivery of advertisements both within and outside the program stream. Under the framework of the SCTE 130 standard, an ADM 250 defines messages in support of advertisement insertion activities and works in conjunction with an Ad Decision Service (ADS) to determine how advertising content is combined with non-advertising content assets. ADM 250 may encompass both the functions of the SCTE 130 ADM and the SCTE 130 ADS.

Placement Opportunity Information Service (POIS) 252 holds, maintains, or retains descriptions of placement opportunities. A placement opportunity is a potentially constrained location relative to digital content where advertisement insertion or content alterations can occur. The alterations may include insertions, replacements, or deletions of content in whole or in part. The POIS may also contain attributes and constraints for each placement opportunity, platform compliance, rights, and policies of the content in which the placement opportunity exists. POIS 252 may be a component of ADM 250 or a separate process.

Web Portal 256 supports delivery of the located advertisements to Internet-connected devices. Web Portal 256 may be a component of ADM 250 or a separate process. Web Portal 256 may use standard techniques for delivery of content and/or links to content via email, HTTP, SMS, or other methods.

The Business Management System (BMS) 272 provides functions related to business operations, such as tracking and reporting VOD access. A single BMS 272 may provide business management functions for multiple VOD servers, running multiple VOD applications, all managed by the same back office.

VOD Server 274 may manage on-demand retrieval and transmission of stored content to STBs 140. The content is generally programming such as television shows or movies. In the methods described below, VOD Server 274 also may serve as the source for viewer-initiated supplemental advertising content.

The Global Session Resource Manager (GSRM) 276 acts a bridge between the STBs 140, the BMS 272 and ERM 278 or Edge QAM resources. GSRM 276 may combine the role of session manager and resource manager. GSRM 276 receives VOD session requests from STBs 140 and interacts with BMS 272 to access the VOD asset. BMS 272 locates the VOD asset, instructs the VOD Server 274 to multicast the VOD to the streaming network, and provides the multicast IP address and port of the VOD stream to GSRM 276. GSRM 276 may then instruct an Edge QAM to join the multicast and allocate appropriate bandwidth to insert the VOD stream into the cable downstream. GSRM 276 instructs STBs 140 to tune the specific channel allocated to the VOD asset. GSRM 276 may manage the lifecycle of VOD sessions, including session setup and teardown.

Edge Resource Manager 278 acts as a bridge between a Session Manager 280 and the Edge QAMs. The Session Manager receives session requests from the STBs 140 and communicates with ERM 278 to allocate QAM bandwidth resources. The ERM process 278 may reside, in certain embodiments, on dedicated EQAM hardware. In embodiments, certain communications of EQAM process 210 and its related hardware may comply with standards such as SCTE 137.

At STB 140, Switched Digital Video (SDV) Client 210, communicates with processes on headend 120 to manage delivery of content. Among other functions, SDV Client 210 may send channel requests to headend 120 and receive information regarding the reception of those channels from headend 120. Communications between SDV Client 210 and headend 120 may occur over cable network 130. In embodiments, certain communications of SDV Client 210 may comply with standards such as SCTE 55.

Video-On-Demand (VOD) Client 220 may receive requests related to on-demand video content and communicate with headend 120 to fulfill them. Communications between VOD Client 220 and headend 120 may occur over cable network 130. In embodiments, certain communications of VOD Client 220 may comply with the SCTE 130 standard.

Ad Management Application 230 performs functions related to selection and presentation of advertisements. In embodiments, Ad Management Application 230 may be responsible for gathering metadata of a playing advertisement or program upon a viewer request for supplemental advertising. The Ad Management Application functions may, in some embodiments, be incorporated into the SDV Client 210.

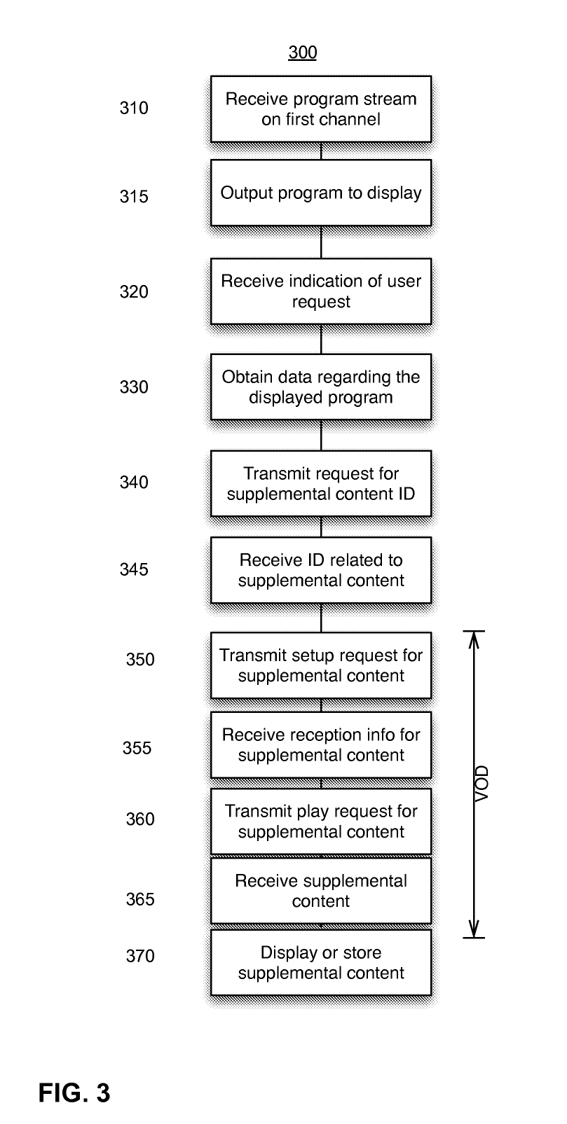

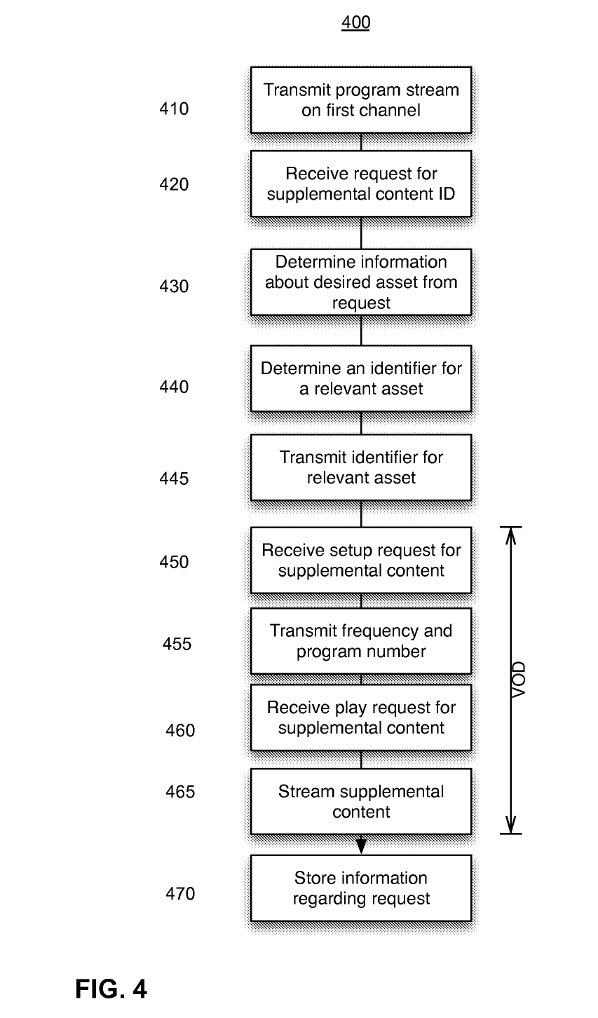

FIG. 3 is a flow chart of a method for allowing viewer initiation of supplemental advertising presentation, shown from the perspective of a set-top box. Program code for the method may be stored in ROM 240 and/or RAM 260, and may be executed by microprocessor 220. The method may involve one or more of the processes of FIG. 2. A STB 140 performing the method illustrated in FIG. 3 may be interacting with a headend 120 performing the method illustrated in FIG. 4.

At 310, STB 140 receives a first program stream on a first channel. The channel carrying the program stream may be tuned by one of the receivers 142. The program stream may be received over cable network 130 from headend 120. The program may be transmitted over cable network 130 using a modulation such as QAM. The program stream may be one of multiple streams comprising an MPEG Transport Stream. The program stream may alternatively be transmitted using computer networking techniques, such as via an IP stream.

At 315, STB 140 outputs a presentation of the program stream to a display 150, such as a television. The output of the program stream may occur during reception 310 or at a later time, such as during playback using a DVR function.

If a viewer is interested in a specific portion of the program stream, such as an advertisement that is playing, and desires more info about the products or services the advertisement is offering, the viewer may interact with the Receiver Control Device (RCD) 160 to request supplemental program content. In embodiments, the supplemental program content may be a longer, more detailed advertisement.

At 320, STB 140 receives an indication from the RCD 160. The indication may be indicative of the press of a specific button for the request of supplemental program content, the selection of a UI element on the RCD related to such a request, or a UI navigation or selection command related to a UI displayed on display 150 for requesting supplemental program content.

At 330, the STB 140 gathers information about the currently displayed portion of the program stream to determine what the viewer was viewing when the indication of interest was expressed. Ad Management Application 230 may gather the information. The information may comprise metadata including the channel ID, the time of the request, a relative time-position within the viewed program stream, and the identity of the service group to which the STB belongs. In embodiments, the service group may instead be determined by the headend based upon other identifying information from the STB. SDV Client 210 may provide the metadata if the viewer's cable environment is deployed with SDV. Other Ad Management Application functions may, in some embodiments, also be incorporated into the SDV Client 210.

At 340, a request for an Asset ID for relevant supplemental program content is transmitted to headend 120. The request may comprise metadata gathered at 330 so as to provide headend 120 with sufficient information to locate relevant supplemental program content. In embodiments, the metadata may be transmitted as an Event Indication message using TWC CCMIS or NGOD CCP (DSM-CC) format. SDV Client 210 may convey the message to Session Manager 280. A custom message descriptor for request of supplemental program content may be used to encapsulate the metadata for the request. The message may be transmitted by transmitter 143 via a return channel on the connection used to send the program stream to STB 140 or via an alternate channel.

Once the message has been received at the headend, headend processes extract the relevant metadata and determine an Asset ID for relevant supplemental program content. That Asset ID is then conveyed back to STB 140. The determination of an Asset ID is described further below with respect to FIG. 4.

At 345, STB 140 receives the requested Asset ID for relevant supplemental advertising content from headend 120. The Asset ID may be received from Session Manager 280.

In some embodiments, the STB may be able to directly determine an Asset ID for supplemental program content from the program stream rather than needing to request the Asset ID from headend 120. An Asset ID may be embedded in the program stream received at 310, for instance, in the form of a Cueing Message as described in the ANSI/SCTE-35 standard. In such cases, 330, 340, and 345 may be omitted.

Once the Asset ID has been obtained, either via a request to the headend or from a cueing message, STB 140 and headend 120 may engage in a VOD operation for delivery of the supplemental advertising content at 350 through 365. One suitable framework for VOD is provided in the SCTE 137 standard.

At 350 the STB transmits a VOD setup request for the supplemental program content to the headend. In embodiments, VOD Client 220 may convey the setup request to VOD GSRM 276. The setup request may include the Asset ID of the supplemental advertisement and an ID of the service group, identifying the location of the STB in the network. In embodiments, Ad Management Application 230 may instruct VOD Client 220 to send a DSM-CC Client Session Setup Message to VOD system 270 Resource Management Device process, such as GSRM 276, to request the VOD session.

At headend 120, the content associated with the Asset ID is located, resources are provisioned with ERM process 278 and associated hardware, and a frequency and program number are assigned. The headend processes are detailed further below with respect to the description of FIG. 4.

At 355, as part of the VOD operation, the STB 140 receives information regarding the reception of the supplement content. In embodiments, GSRM 276 returns the frequency and program number to VOD client 220 for the stream that will contain the supplemental advertisement.

At 360, STB 140 sends a request for playback of the supplemental advertisement to headend 120. In embodiments, VOD client 220 directs the GSRM 276 or VOD Server 274 to start streaming the content. The STB 140 may then tune the indicated channel to allow reception of the supplemental program content. Further discussion of the initiation of streaming from the headend 120 is provided below with respect to FIG. 4.

At 365, STB 140 receives a stream comprising the supplemental program content. The stream may comprise a Single Program Transport Stream (SPTS) VOD stream of the detailed advertisement delivered to a second receiver 142 of STB 140. STB 140 may tune a secondary receiver 142 to a channel indicated channel to allow receipt of the supplemental advertisement. In embodiments, the supplemental program content may be automatically shown on display 150 full-screen or as PIP (Picture In Picture). In other embodiments, an SPTS VOD stream of the supplemental program content may be recorded in storage 148 for later retrieval.

At 370, the received supplemental advertisement is output to a display for viewing or stored. Output may occur during reception 365 or at a later time.

When the supplemental program content delivery is complete, Ad Management Application 230 may instruct STB 140 to stop displaying the stream received on the second channel and return to the first stream, or to stop recording the stream to DVR storage 148.

While the method has been described with reference to “channels,” the method may also be performed using data streams over a network. In other embodiments, the supplemental program content may be delivered in other forms via the Internet, such as URLs, allowing access via a browser, or directly delivered HTML pages or Java applets. The supplemental program content may be delivered to the viewer's email address if the viewer has opted to set up a web profile account with the cable TV service provider.

FIG. 4 is a flow chart of a method for allowing viewer initiation of supplemental advertising presentation, shown from the perspective of a headend. In embodiments, the method of FIG. 3 would be performed on STB 140 while the method of FIG. 4 is performed at headend 120.

At 410, headend 120 delivers a program stream to one or more STBs 140 on a first channel. Headend 120 will generally comprise multiple transmitters 122 to allow transmission of multiple program streams at the same time. In embodiments, the transmitted program is received by STB 140 at 310. The transmitted program stream may comprise a television program selected by a viewer via STB 140.

At 420, a process such as Session Manager 280 at headend 120 receives a request for an Asset ID of supplemental advertising content. The request may contain metadata regarding the time the request was made, a relative time-position within the viewed program stream, the service group from which the request initiated, and the channel being displayed at the time of the request. In embodiments, Session Manager 280 receives a DSM-CC Event Indication message. The request for supplemental program content may be the request sent by a STB at 340.

At 430, the metadata is extracted from the request for use in location of a relevant supplemental advertisement. Session Manager 280 may relay the metadata to an Ad Delivery Manager (ADM) 250. The metadata may comprise the metadata gathered by STB 140 at 330.

At 440, an Asset ID for the relevant supplemental program content is determined Headend 120 determines information regarding the desired asset from information contained in the request. In embodiments, a Placement Opportunity Information Service (POIS) 252 may locate the relevant advertisement in the CCMS Ads Schedule and Verification Files using the metadata. The functions of POIS 252 may be incorporated in ADM 250 or may exist as a separate process. A Viewer Service Group indication in the metadata may be used to link the specific Ad Zone such that the right Ads Schedule and Verification Files are used. The located advertisement may be identified with a unique Spot ID. Besides the POIS 252, ADM may also contain an Ads Decision Database, which stores the playing ads Spot ID and the detailed advertisement Asset ID association. The Asset ID is used for requesting the VOD SPTS or web content of the detailed advertisement. Once located, the Asset ID is conveyed back to the Session Manager 280, and then transferred back to the Ad Management Application in viewer's STB 140, via one of the DSM-CC messages, such as the Event Indication message. The role of ADM and interfaces between various server devices may comply with the corresponding ANSI/SCTE-130 interface protocols.

At 445, the Asset ID for the supplemental advertisement is returned to STB 140. The Asset ID may be conveyed by Session Manager 280 to VOD Client 220. The Asset ID may be received at STB 140 at 345.

In alternative embodiments, the Asset ID may be determined by the STB directly from the program stream being viewed. In such cases, steps 430, 440, and 445 may be omitted, since the STB may directly request the desired supplemental advertising content without the need for headend lookup of the Asset ID.

Once the Asset ID has been obtained, either via a request to the headend or from a cueing message, STB 140 and headend 120 engage in a VOD operation for delivery of the supplemental advertising content at 450 through 465. One suitable framework for VOD is provided in the SCTE 137 standard.

At 450, GSRM 276 receives a setup request from VOD client 220. The setup includes Asset ID of the content to be streamed and the service group, identifying the location of the STB in the network. The request corresponds to that sent at 350. In embodiments, GSRM 276 then requests bandwidth from ERM 278, which selects the QAM on an Edge QAM device that has sufficient bandwidth. ERM 278 or an Edge QAM may then return the IP address of the Edge QAM device and a UDP port to which VOD Server 274 should send the SPTS. The ERM or EQAM also provides the frequency on which the MPEG program will be transmitted and the program number within the QAM RF corresponding to the program.

At 455, an indication of the frequency and program number that will be used for transmission of the supplemental program content is conveyed to STB 140. The indication is received at STB 140 at 355 in the process described above. The frequency and program number may be conveyed by GSRM 276 to VOD Client 220.

At 460, headend 120 receives a request from STB 140 requesting the start of streaming of the supplemental program content. In embodiments, GSRM 276 receives the request from VOD Client 220 and directs the VOD Server 274 to create a stream for the content. VOD server 274 then streams the content to selected EQAM by directing the SPTS to the IP address of the EQAM and sending on the destination UDP port that corresponds to the RF output port serving the selected frequency and program number passed into the EQAM.

At 465, headend 120 sends a stream comprising the supplemental program content to STB 140 on the channel indicated at 460. The stream may comprise a Single Program Transport Stream (SPTS) VOD stream of supplemental program content related to the Asset ID determined at 430-445.

At 470, statistics are gathered and stored. ADM 250 may maintain a database of supplemental advertisement events with detailed properties, including advertisement IDs, delivery channels, viewer IDs, viewer service groups, delivery time, delivery duration, etc. Reports can be generated on this database to measure the effectiveness of the viewer-initiated supplemental advertising delivery. The ability to measure the effectiveness of advertising based upon viewer engagement via requests for supplemental advertising may provide opportunities for significantly higher advertising revenues.

For Internet delivery, ADM 250 may convey the Asset ID, along with the viewer STB ID such as set-top unit address, to the ADM Web Portal 256. The ADM Web Portal 256 may access or create web-accessible content, such as HTML pages or Java applets, of the detailed advertisement and its linkage to the Asset ID. ADM Web Portal 256 may also contain a Viewer Account Database that stores the association of viewer email address to the STB ID. ADM Web Portal is responsible for locating the Web content of the detailed advertisement based on the Asset ID and the viewer email address based on the STB ID, and sending the content or links to access the content to the viewer email address.

While the principles of the disclosed techniques have been described above in connection with specific apparatus, it is to be clearly understood that this description is made only by way of example and not as a limitation on the scope. For instance, advertising is merely on exemplary type of supplemental program content that could be provided in response to a viewer request for additional information. Other types of supplemental information may include extended interview content, additional sports highlights, or more detailed weather forecasts.

The foregoing detailed description has set forth various embodiments of the devices and or processes via the use of block diagrams, flowcharts, and examples. Insofar as such block diagrams, flowcharts, and examples contain one or more functions and or operations, it will be understood by those within the art that each function or operation within such block diagrams, flowcharts, or examples can be implemented individually or collectively by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits or as one or more computer programs running on one or more computers. In addition, those skilled in the art will appreciate that the mechanisms of the subject matter described herein are capable of being distributed as a program product in a variety of forms, and that an illustrative embodiment of the subject matter described herein applies regardless of the particular type of computer readable medium used for distribution.

It is to be understood that the depicted architectures are merely exemplary and that in fact many other architectures can be implemented which achieve the same functionality. In a conceptual sense any arrangement of components to achieve the same functionality is effectively associated such that the desired functionality is achieved.

While particular aspects of the present subject matter described herein have been shown and described, it will be apparent to those skilled in the art that based upon the teachings herein, changes and modifications may be made without departing from the subject matter described herein and its broader aspects, and therefore, the appended claims are to encompass within their scope all such changes and modifications as are within the true spirit and scope of the subject matter described herein.

1. A method of accessing advertising content, said method comprising:
receiving a first program stream comprising said advertising content;
outputting said first program stream to a display;
receiving an indication of a viewer request for supplemental advertising content specific to said advertising content for more information about said advertising content;
obtaining an identifier related to said supplemental advertising content;
requesting said supplemental advertising content using said identifier;
receiving reception information related to said supplemental advertising content in response to requesting said supplemental advertising content using said identifier; and
receiving said supplemental advertising content based upon said reception information.

2. The method of claim 1 wherein obtaining an identifier comprises:
obtaining information related to a presently displayed portion of said first program stream;
transmitting a request for supplemental advertising content comprising said obtained information; and
receiving an identifier of said supplemental advertising content.

3. The method of claim 2 wherein obtaining information related to the presently displayed portion of said first program stream comprises obtaining at least one of a channel ID, a time of the indication, a relative time-position within said first program stream, and an identity of a service group.

4. The method of claim 2 wherein said request for supplemental advertising content comprises metadata related to the first program stream.

5. The method of claim 2 wherein said request for supplemental advertising content comprises a TWC CCMIS or NGOD CCP (DSM-CC) message.

6. The method of claim 1 wherein obtaining an identifier comprises extracting an Asset ID from a Cueing Message accompanying said advertising content.

7. The method of claim 1 wherein receiving reception information related to said supplemental advertising content comprises receiving an indication of a frequency and a program number.

8. The method of claim 7 wherein said first program stream is received on a first frequency tuned by a first receiver and said supplemental advertising content is received on said frequency from said reception information and tuned with a second receiver.

9. The method of claim 1 further comprising at least on one of: storing said supplemental advertising content to a memory or outputting said supplemental advertising content to a display.

10. The method of claim 1 wherein said viewer request for supplemental advertising content is an indication of a viewer input on a receiver control device.

11. The method of claim 1 wherein said supplemental advertising content is received via a single program transport stream (SPTS).

12. The method of claim 1 wherein said supplemental advertising content comprises advertising information related to advertising displayed at or near the time said viewer request for supplemental advertising content was received.

13. The method of claim 1 wherein said indication of a viewer request for supplemental advertising content is received from a handheld computing device.

14. A method of providing advertising content, said method comprising:
transmitting a first program stream comprising said advertising content;
receiving a request for supplemental advertising content, said request comprising metadata;
identifying supplemental advertising content using said metadata from said request;
sending reception information for said identified supplemental advertising content; and
transmitting supplemental advertising content in accordance with said reception information.

15. The method of claim 14 wherein said metadata comprises at least one of a channel ID, a time of the request, a relative time-position within said first program stream, and the identity of a service group related to the request.

16. The method of claim 14 wherein identifying supplemental advertising content comprises determining the identity of an advertisement displayed at or near the time of said request and identifying supplemental advertising content related to said advertisement.

17. The method of claim 14 wherein said first program stream is transmitted on a first channel using a first transmitter and said supplemental advertising content is transmitted on a second channel using a second transmitter.

18. An apparatus for accessing supplemental program advertising content comprising:
a first RF receiver for receiving a first program stream comprising said advertising content;
a video output for outputting said first program stream to a display;
a processor for performing:
receiving an indication of a viewer request for supplemental advertising content specific to said advertising content for more information about said advertising content;
obtaining an identifier related to said supplemental advertising content;
requesting said supplemental advertising content using said identifier; and
receiving reception information related to said supplemental advertising content in response to requesting said supplemental advertising content using said identifier; and
a second RF receiver for receiving said supplemental advertising content based upon said reception information.

19. The apparatus of claim 18 wherein obtaining an identifier comprises:
obtaining information related to a presently displayed portion of said first program stream;
transmitting a request for supplemental advertising content comprising said obtained information; and
receiving an identifier of said supplemental advertising content.

20. The apparatus of claim 19 wherein obtaining information related to the presently displayed portion of said first program stream comprises obtaining at least one of a channel ID, a time of the indication, a relative time-position within said first program stream, and an identity of a service group.

21. The method of claim 1 wherein requesting said supplemental advertising content using said identifier comprises sending the identifier and requesting supplemental video advertising content via a VOD operation to receive the supplemental video advertising content.

22. The apparatus of claim 18 wherein requesting said supplemental advertising content using said identifier comprises sending the identifier and requesting supplemental video advertising content via a VOD operation to receive the supplemental video advertising content
